(19) United States
(12) Patent Application Publication
(10) Pub. No.: US 2025/0108380 A1
(43) Pub. Date: Apr. 3, 2025

(54) DEVICE AND METHOD FOR SEALING A SAMPLE CONTAINER

(71) Applicant: Roche Diagnostics International AG, Rotkreuz (CH)

(72) Inventors: Rolf Schneebeli, Mettmenstetten (CH); Brendan Strickler, Neuheim (CH)

(21) Appl. No.: 18/899,335

(22) Filed: Sep. 27, 2024

(30) Foreign Application Priority Data
Sep. 29, 2023 (EP) 23200733.6

(51) Int. Cl. B01L 3/00; B65B 7/16

(52) U.S. Cl. CPC B01L 3/50853; B65B 7/162; B01L 2200/0689; B01L 2200/12

(57) ABSTRACT

A device for manually sealing a multiwell plate is described. The device includes a multiwell plate holder, a frame movably arranged and configured to frame the multiwell plate for holding and centering a precut adhesive foil placed on the multiwell plate, wherein the frame is configured for transmitting a pressure force onto the adhesive foil, and a handle portion including a roller moveable across the frame and the adhesive foil for applying pressure onto the adhesive foil to thereby seal the multiwell plate.

### CROSS-REFERENCE TO RELATED APPLICATIONS

This application claims the benefit of priority of European Application Serial No. 23200733.6, filed Sep. 29, 2023, the disclosure of which is incorporated herein by reference.

### TECHNICAL FIELD

Generally, the present invention relates to the technical field of sample analysis, such as the analysis of biological samples, and further to the technical field of high throughput analysis of biological samples. In particular, the present invention is directed to a device for manually sealing sample vessels or sample containers, such as multiwell plates, to the use of such a device, and to a method for sealing a multiwell plate.

### BACKGROUND

In the field of biological, biochemical, diagnostic or therapeutic applications, it is usually desired to be able to correctly determine the amount or concentration of a certain substance or compound in a biological sample, such as an analyte, a certain antigen or a nucleic acid, for example a biological sample contained in a reaction mixture or the like. For achieving this goal accurately, methods have been developed over the years, such as the enzyme-linked immunosorbent assay (ELISA), or the widely known Polymerase Chain Reaction (PCR), for example in the form of a real-time PCR (rtPCR), digital PCR (dPCR) or multiplex PCR, which enable the in vitro synthesis of nucleic acids in a biological sample, through which a DNA segment can be specifically replicated, i.e. a cost-effective way to copy or amplify small segments of DNA or RNA in the sample. Further developing these methods for amplifying DNA or RNA segments has generated enormous benefits in gene analysis as well as the diagnosis of many genetic diseases, or also in the detection of viral load. In this regard, thermal cycling, also referred to as thermocycling, is usually used to provide heating and cooling of reactants in a sample provided inside a sample vessel, such as a reaction vessel for amplifying such DNA or RNA segments, wherein so-called thermocycler are commonly used in order to achieve an automatic procedure of diagnostic assays based on PCR, in which, during a PCR conduct, the liquid PCR-samples as well as the respective reactants have to be initially transferred into the sample vessel before being heated and cooled to differing temperature levels repeatedly. During processing of the content of such reaction vessels, the same must be sealed inside the vessel in a safe, and preferably fluid-tight manner, in order to avoid the possibility of cross-talk, or of any other kind of contamination, or also in order to avoid biohazard for a user.

Known methods and devices for sealing sample containers exhibit, inter alia, the disadvantage that undesired leakages are highly likely to occur, in particular in the peripheral regions of the sample containers. Thus, there is the ongoing need to provide a reliable and particularly leakage-free sealing of sample or reaction vessels in the analysis of biological samples.

### SUMMARY

The above mentioned need can be met by the present invention, in particular by the subject-matter of the independent claims appended hereto.

It has been surprisingly found by the inventors of the present invention that, if a biased roller is driven over a foil for sealing vessels, the whole sealing area is much more evenly pressed, resulting in an overall tighter sealing and, thus, leakage can be prevented in a more sufficient manner. The biased roller can, on the one hand, be designed to build up its pretension, i.e., the bias of the biased roller, and, on the other hand, to compensate for tolerances that may arise during the production of the multiwell plates. In addition, significant structural differences which occur when comparing e.g. a 96-well-plate to a 384-well-plate by design, can also be compensated by the use of such biased roller. The device of the present invention has the advantage that the foil used to seal the multiwell plate is automatically centred and held in place in a very accurate manner. This serves to keep the foil in the desired position during handling. Thus, the device of the present invention ensures a safe and comfortable handling, and overall improves the use of multiwell plates when experimenting with or analyzing biological samples.

It is one advantage of the present invention that fewer components are needed than in sealing devices thus far known in the art. Furthermore, the device according to the invention can basically work purely manually, without the necessity of electricity, although it may be powered by electricity when implemented in accordance with some embodiments of the present invention. The device of the present invention may furthermore be used independently and is not bound to one specific (analytical) instrument, such as an analytical instrument in a laboratory or the like. Hence, sample preparation, and in particular the sealing of one or a plurality of sample containers may take place independently before entering the plate into the respective instrument.

According to a first aspect of the present invention, there is provided a device for manually sealing a multiwell plate, the device comprising: a multiwell plate holder, a frame movably arranged and configured to frame the multiwell plate, for holding and centering a precut adhesive foil placed on the multiwell plate, wherein the frame is configured for transmitting a pressure force onto the adhesive foil, and a handle portion comprising a roller moveable across the frame and the adhesive foil, for applying pressure onto the adhesive foil to thereby seal the multiwell plate.

According to a second aspect of the present invention, there is provided a method of use of a device according to any of the preceding claims for manually sealing a multiwell plate by means of an adhesive foil, wherein the multiwell plate is sealed by manually moving the handle portion from the initial position along the whole length of the multiwell plate to the stopping position and back to the initial position, for applying pressure onto the adhesive foil by means of the roller of the device.

According to a third aspect of the present invention, there is provided a method for sealing a multiwell plate, the method comprising: (i) placing a multiwell plate in the multiwell plate holder of a device according to any one of the preceding claims, (ii) placing an adhesive foil onto the multiwell plate, (iii) placing the frame of the device onto adhesive foil and multiwell plate, for centering and holding in place the adhesive foil, and (iv) sealing the multiwell plate by manually moving the handle portion from an initial position along the whole length of the multiwell plate to a stopping position and back to the initial position, for applying pressure onto the adhesive foil by means of the roller of the device.

According to an embodiment of the present invention, the device is configured such that the handle portion can be manually moved from an initial position along the whole length of the multiwell plate to a stopping position and back to the initial position. Preferably, the device is configured such that the frame is only removable from the multiwell plate, and the multiwell plate is only removable from the multiwell plate holder, when the handle portion is in its initial position. This has the beneficial technical effect that the multiwell plate and the foil are accurately held in place until the sealing process has been finished.

According to another embodiment of the present invention, the frame is movably attached to the multiwell plate holder, in particular by means of a hinge, such that the frame can be folded onto the adhesive foil placed on the multiwell plate, and opened again, in the manner of a hinged cover. This ensures easy and comfortable handling of the device.

According to a further embodiment of the present invention, the frame comprises a mechanism for preventing the frame from folding by itself, in particular wherein the hinge is one of a friction and torque hinge. This ensures that, while positioning the multiwell plate in the multiwell plate holder, the frame does not fold by itself and hence does not collide with the multiwell plate, which would cause spilling or even damage. It is another advantage that only one hand may be required to place the multiwell plate in the device, since no second hand is needed to hold the frame in its opened position while placing the multiwell plate in the device.

According to an embodiment of the present invention, the roller comprises a soft material, or in other words, a material with a very low hardness. In some embodiments, the roller is coated with the soft material, i e. has an outer surface (the surface that comes into contact with the adhesive foil and/or the frame), that comprises the soft material. According to an exemplary embodiment, the hardness in accordance with DIN 53505 may be about 60±5 shore A at 20° C. For example, the hardness of the material in accordance with DIN 53505 at −5° C. may be 68 shore A, or 59 shore A at +80° C. In an exemplary embodiment, the material is a polymer, in particular an organic polymer, such as polyurethane, which is for example composed of or comprises a prepolymer, a polyol ether, and an extender. A resilience of the material according to DIN 53512 is preferably 75%, although the skilled person will appreciate that some materials may have a lower or higher resilience while still being suitable for the invention at hand. The material, in particular said polyurethane, may have the benefit that it is particularly resistant to abrasion, very resistant to hydrolysis, has a beneficial behavior at low temperatures, a high resilience, and in further particular cases it may be compliant with requirements of the Food and Drug Administration (FDA), which is especially desired in pharmaceutical and/or (bio)chemical or biotechnological applications. Using such a material in embodiments of the invention has the advantage that an unevenness or irregularities of the multiwell plate can be compensated and pressure may be applied constantly and evenly. Furthermore, the soft material may contribute to a pretension or bias force acting on the foil. In some embodiments, the whole roller may be made of or comprise the soft material, in other embodiments, the roller, which substantially has the shape of a cylinder, has a core that differs from the outer layer with regard to softness.

According to an embodiment of the present invention, the handle portion is mounted onto the device by means of a ball bearing mechanism. Other forms of bearings such as a sliding bearing mechanism could also be used, according to other embodiments. The device thus ensures a comfortable handling. Furthermore, this has the advantage of consistent handling even if the dimensions of the multi-well plates vary within manufacturing tolerance.

According to an embodiment of the present invention, the roller is mounted within the handle portion by means of a ball bearing mechanism. This also leads to comfortable handling and also ensures consistent handling even if the dimensions of the multi-well plates vary within manufacturing tolerance.

According to an embodiment of the present invention, the roller is biased away from the handle portion by means of a biasing mechanism, for evenly applying a force onto the frame and onto the adhesive foil placed on the multiwell plate, preferably wherein the biasing mechanism comprises a spring. Preferably, the resulting biasing force is substantially perpendicular to the extension plane of the foil and the multiwell plate. This has the advantage that unevenness or irregularities of the multiwell plate can be compensated and pressure may be applied constantly and evenly.

According to an embodiment of the present invention, the multiwell plate holder comprises a plurality of support structures arranged in a fixed manner, for supporting and holding in place the multiwell plate. Such a configuration may ensure that the multiwell plate is held in place safely during sealing and thus ensures an accurate sealing of the multiwell plate.

According to an embodiment of the present invention, the support structures are formed to correspond to a plurality of recesses on the bottom side of a respective multiwell plate. Preferably, the support structures are formed for accommodating different types of multiwell plates in the multiwell plate holder, and for preventing a deformation of the multiwell plate by directing a force applied by the roller to collars of the respective wells of the multiwell plate, as well as to edge regions of the multiwell plate.

According to an embodiment of the present invention, the support structures each protrude vertically from the multiwell plate holder and/or each have a cross-sectional area that is round or polygonal, in particular quadrangular, such that the support structures each have a conical shape or a pyramid shape, respectively.

According to an embodiment of the present invention, the multiwell plate is a 96- or 384-well-plate.

In an embodiment of the method for sealing a multiwell plate, the step of sealing the multiwell plate by manually moving the handle portion from an initial position along the whole length of the multiwell plate to a stopping position and back to the initial position is repeated at least once. This ensures a particularly tight and therefore safe sealing.

Further aspects and advantages of the present invention will become apparent from the following description of the specific embodiments illustrated in the figures.

### BRIEF DESCRIPTION OF THE DRAWINGS

FIG. 1 shows the device for manually sealing a multiwell plate according to an embodiment of the present invention;

FIG. 2 shows a detail of the multiwell plate holder, according to an embodiment of the present invention;

FIGS. 3A & 3B show a side view and top view of the device for manually sealing a multiwell plate according to an embodiment of the present invention;

FIGS. 4A & 4B show the device for manually sealing a multiwell plate according to an embodiment of the present invention, wherein the handle portion is in a different respective position; and

FIGS. 5A & 5B show the device for manually sealing a multiwell plate according to an embodiment of the present invention in an exploded view, with the frame 4 in different positions.

### LIST OF REFERENCE NUMERALS

1 Device for manually sealing a multiwell plate
2 Multiwell plate
3 Multiwell plate holder
31 Base
311 Bulge
312 Edge
313 Recess
314 Pedestal
4 Frame
41 Rib
5 Adhesive foil
6 Mechanism
7 Handle portion
71 Groove
8 Roller
9 Support structures
10 Bearing mechanism
L Length direction
P Initial position
S Stopping position

### DETAILED DESCRIPTION

In the context of this disclosure, the term “manually” may in particular refer to a process carried out by a user with his own force, i.e. without the assistance of machine power, such as a motor. In other words, in the context of this invention, if something is done manually, it is not done automatically or by using an electronic system or any kind of electronic support.

In the context of the present disclosure, the term “sealed” or “sealing”, used as a noun or verb, encompasses hermetical sealing of the content of the sample vessel by means of a sealing cover, such as an (adhesive) foil. In the case of an adhesive foil, the term “adhesive” in particular means that the foil is self-adhesive, i.e. no adding of an additional agent such as the addition of glue is required. The adhesive effect may, for example, occur after pressure is applied to the adhesive foil, i.e. the adhesive foil is pressed onto an object, such as a multiwell plate to be sealed. If the foil is “precut”, this means in the context of the present invention that a piece of foil is used, the size of which already corresponds to the required size, i.e. the area and shape already corresponds to the area and shape of the multiwell plate to be sealed.

In the context of this disclosure, a “multiwell plate”, also known as “multiplate” or “microtiter plate”, is a usually flat, rectangular plate comprising multiple tubular wells, which can be arranged in rows (for examples rows A-H) and columns (for example columns 1-12), and which serve as reaction vessels and usually have a capacity of a few millilitres (mL) down to as little as a few microliters (μL). Different kinds of multiwell plates are already known to the skilled person and are commercially available. Various commercially available multiwell plates from different manufacturers are known, all of which are encompassed by the present invention. Some multiwell plates have, for example, a corner notch (aka chamfer) at one or more corners. Usually, the positions of the wells are standardized. Known formats are well plates with 6, 12, 24, 48, 96, 384, 1536 or 3456 wells. The skilled person will appreciate that all dimensions in the context of this invention are in relation to the substantially standardised dimensions of the aforementioned multiwell plates.

As used herein and also in the appended claims, the singular forms “a”, “an”, and “the” include plural reference unless the context clearly dictates otherwise. Similarly, the words “comprise”, “contain” and “encompass” are to be interpreted inclusively rather than exclusively; that is to say, in the sense of “including, but not limited to”. Similarly, the word “or” is intended to include “and” unless the context clearly indicates otherwise. The terms “plurality”, “multiple” or “multitude” refer to two or more, i.e. 2 or >2, with integer multiples, wherein the terms “single” or “sole” refer to one, i.e. =1. Furthermore, the term “at least one” is to be understood as one or more, i.e. 1 or >1, also with integer multiples. Accordingly, words using the singular or plural number also include the plural and singular number, respectively. Additionally, the words “herein”, “above”, “previously” and “below” and words of similar import, when used in this application, shall refer to this application as a whole and not to any particular portions of the application.

Furthermore, certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “base”, “above”, “upper”, “top”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. The description of specific embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize. Specific elements of any foregoing embodiments can be combined or substituted for elements in other embodiments.

Furthermore, while advantages associated with certain embodiments of the disclosure have been described in the context of these embodiments, other embodiments may also exhibit such advantages, and not all embodiments need necessarily exhibit such advantages to fall within the scope of the disclosure as defined by the appended claims. If applicable, technical features from a device or system claim can be used in the course of the claimed method or use, or vice versa. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for the reason of lucidity, if in a section of a drawing not all features of a part are provided with reference signs, it is referred to other sections of the same drawing. Like numbers in two or more figures represent the same or similar elements.

The following examples are intended to illustrate specific embodiments of the present invention. As such, the specific modification as discussed hereinafter is not to be construed as limitation on the scope of the present invention. It will be apparent to the person skilled in the art that various equivalents, changes, and modifications may be made without departing from the scope of the present invention, and it is thus to be understood that such equivalent embodiments are to be included herein.

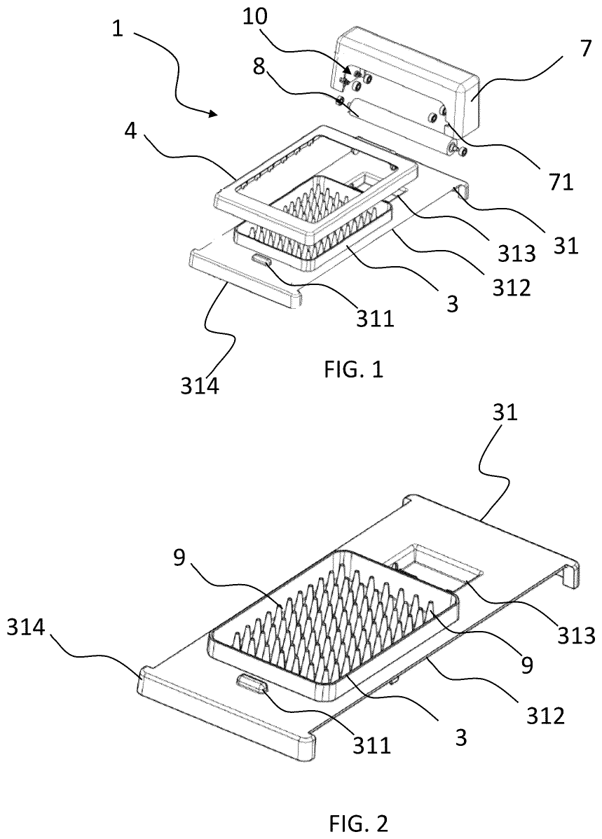

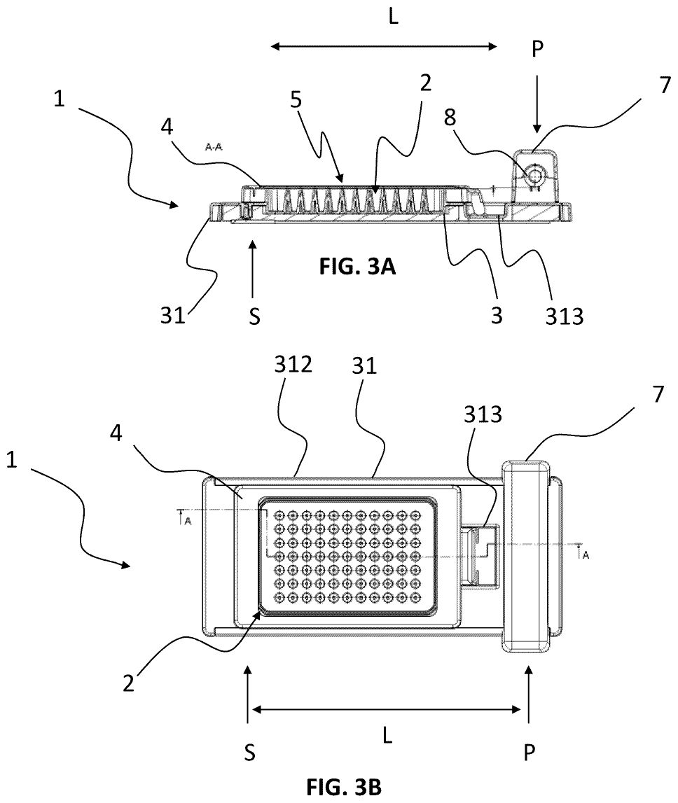

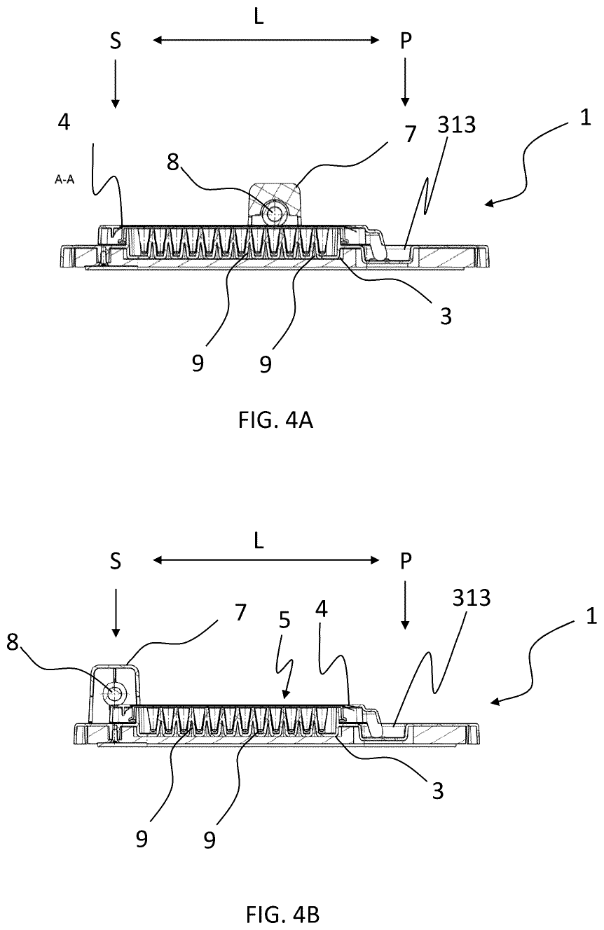

FIG. 1 depicts the device 1 for manually sealing a multiwell plate according to an embodiment of the present invention. According to the embodiment, the device 1 for manually sealing a multiwell plate 2 (not shown in FIG. 1) comprises a multiwell plate holder 3, which has a base 31. In addition, the device 1 comprises a frame 4 movably arranged and configured to frame the multiwell plate 2, for holding and centering a precut adhesive foil 5 (not shown in FIG. 1) to be placed on the multiwell plate 2. The frame 4 is configured for transmitting a pressure force onto the adhesive foil 5. Furthermore, the device 1 comprises a handle portion 7. The handle portion 7 comprises a roller 8 moveable across the frame 4 and the adhesive foil 5, for applying pressure onto the adhesive foil 5 to thereby seal the multiwell plate 2. The handle portion 7 may comprise grooves 71 on its inner side. Each groove 71 corresponds to an edge 312 of the base 31 and ensures that the handle portion 7 is evenly guided along a length direction L, see e.g. FIG. 4A, without any offset in a height direction. Thus, pressure can be applied evenly and constantly onto the frame 4 and the foil 5. According to another embodiment, the roller 8 can be mounted within the handle portion 7 by means of a ball bearing mechanism 10. According to a further embodiment of the present invention, the roller 8 can be biased away from the handle portion 7 by means of a biasing mechanism (not shown), for evenly applying a force onto the frame 4 and thus onto the adhesive foil 5 placed on the multiwell plate 2. The biasing force can originate, for example, from a spring of the biasing mechanism. The resulting biasing force can be substantially perpendicular to a plane of extension of the foil 5, i.e. the plane of extension of the multiwell plate 2, i.e. basically a horizontal plane in e.g. FIG. 3A, 4A or 4B. This has the advantage that unevenness or irregularities of the multiwell plate 2 can be compensated, and pressure may be applied constantly and evenly. According to some embodiments, the base 31 can comprise pedestals 314 such that it is slightly elevated with regard to a working surface.

FIG. 2 shows a detail of the multiwell plate holder 3, according to an embodiment of the present invention. In more detail, the multiwell plate holder 3 depicted in FIG. 2 comprises a plurality of support structures 9 arranged in a fixed or integral manner, for supporting and holding in place the multiwell plate 2, which is not shown in FIG. 2 for the sake of better illustration of the multiwell plate holder 3. The support structures 9 are formed to correspond to a plurality of recesses on a bottom side of a respective multiwell plate 2. Such support structures can prevent a deformation of the multiwell plate 2, which may occur when a force is applied by the roller 8 to collars/circumferential rims of the respective wells of the multiwell plate 2, as well as to edge regions of the multiwell plate 2. According to the embodiment illustrated in FIG. 2, the support structures 9 each protrude away from a base or ground plate of the multiwell plate holder 3, Further the support structures 9 each have a cross-sectional area that is substantially round, wherein the support structures 9 each can exhibit a conical shape, with the conical shape having a reducing outer diameter with increasing distance from the base of the multiwell plate holder 3. Such a configuration may ensure that the multiwell plate 2 is held in place safely during sealing and thus ensures an accurate sealing of the multiwell plate 2.

FIG. 3A and FIG. 3B show a side view and top view, respectively, of the device 1 for manually sealing a multiwell plate 2 according to an embodiment of the present invention. The device 1 as depicted is configured such that the handle portion 7 can be manually moved from an initial position P along the whole length of the multiwell plate 2 to a stopping position S, and back to the initial position P. While the handle portion 7 is moved in a linear movement across the frame 4 in the length direction L, the roller 8 revolves around its axis, unrolling over the top surface of the foil 5 for applying pressure thereto. In FIGS. 3A and 3B, the frame 4 is in a position that may be referred to as a closed position. If the device is configured accordingly, in this position, the frame 4 is removable, in the sense of a swiveling or hinged movement, from the multiwell plate 2, and the multiwell plate 2 is then removable from the multiwell plate holder 3, because the handle portion 7 is in its initial position P, i.e. with a predetermined distance away from the frame 4 and the multiwell plate 2.

In contrast to the handle portion 7 being in its initial position P, FIG. 4A and FIG. 4B show the device 1 for manually sealing a multiwell plate according to an embodiment of the present invention with the handle portion 7 in differing positions. In FIG. 4A, the handle portion 7 is manually moved from the initial position P along a longitudinal direction of a length L of the multiwell plate 2 towards a stopping position S. In this position in between the initial position P and the stopping position S, the frame 4 is not removable from the multiwell plate 2, and the multiwell plate 2 is thus not removable from the multiwell plate holder 3, because the handle portion 7 is not in its initial position P. In FIG. 4B, the same applies, i.e., the frame 4 is not removable from the multiwell plate 2, and the multiwell plate 2 is thus not removable from the multiwell plate holder 3, since the handle portion 7 is in the stopping position S, from where it can be manually moved back along the direction of length L up until the initial position P. In some embodiments, the step of sealing the multiwell plate 2 by manually moving the handle portion 7 from the initial position P along the whole length L of the multiwell plate 2 to a stopping position S and back to the initial position P can be repeated at least once. This ensures a particularly tight and therefore safe sealing. As can be taken from FIGS. 4A & 4B, the plate 31 can comprise a recess 313, in which the hinge structure of the frame 4 can be arranged, i.e. a pivot point of the hinged frame 4 is positioned below a top surface of the base 31. This ensures sufficient freedom of hinge movement for the frame 4, combined with a less complex setup. Furthermore, the hinge structure does not obstruct the way of movement of the handle portion 7 along the length direction L, since it is arranged in the recess 313 below a movement surface of the handle portion 7.

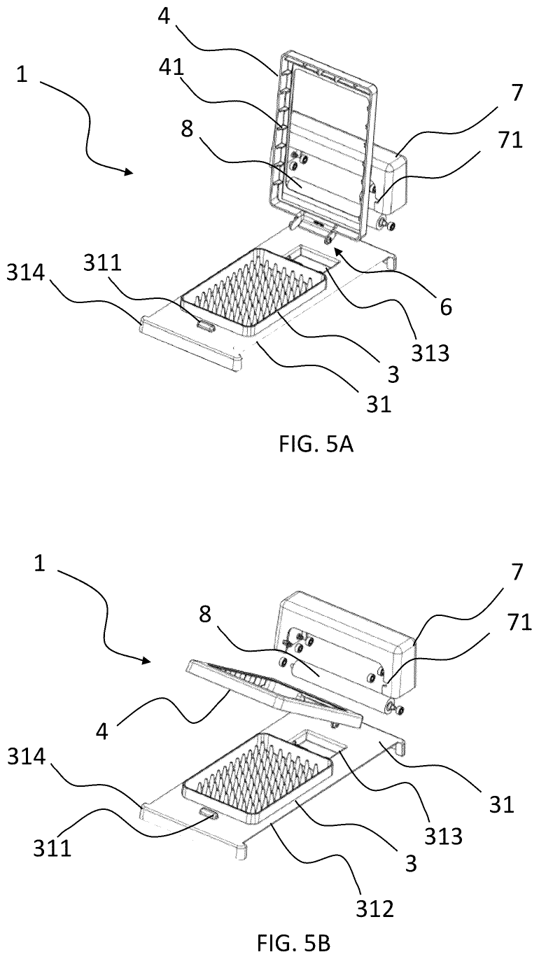

FIG. 5A and FIG. 5B again illustrate the device 1 for manually sealing a multiwell plate according to an embodiment of the present invention without a multiwell plate 2, with the multiwell plate holder 3, the frame 4 and the handle portion 7 in an exploded view, and with the frame 4 in different orientations in FIGS. 5A and 5B. In general, as can be gathered from FIGS. 5A and 5B, the frame 4 is movably attached to the multiwell plate holder 3. As shown, this is done by means of a hinge structure or the like, such that the frame 4 can be folded onto the adhesive foil 5 (not shown in FIGS. 5A and 5B for the sake of better illustration) to be placed on the multiwell plate 2 (also not shown in FIGS. 5A and 5B for the sake of better illustration), and opened again, in the manner of a hinged cover. In particular, in FIG. 5A, the frame 4 is in a position that can be referred to as an open position, and FIG. 5B shows the frame 4 in a position in between open position and closed position, i.e., during opening or closing. In the embodiment as shown in FIGS. 5A and 5B, the frame 4 comprises a mechanism 6 for preventing the frame 4 from folding by itself. For example, the hinge structure can be implemented by one or several friction or torque hinges or the like. In other examples, the mechanism 6 may comprise a spring or other biasing means to ensure that the frame 4 does not fold by itself. This ensures that, while positioning the multiwell plate 2 in the multiwell plate holder 3, the frame 4 does not fold by itself and hence does not collide with the multiwell plate 2, which would cause spilling or even damage. As a further advantage, only one hand may be required by a user to place the multiwell plate 2 in the device 1, since no second hand is needed to hold the frame 4 in its opened position while placing the multiwell plate 2 in the device 1. As can be taken from FIG. 5A, the frame 4 can comprise a plurality of ribs 41 for ensuring sufficient stiffness of the frame 4. Furthermore, the ribs 41 may correspond to an outer shape of the multiwell plate 2, for holding the multiwell plate 2 in place in a closed state of the frame 4, to ensure a safe and leakage free sealing of the multiwell plate 2 with the foil 5. As shown in FIGS. 1, 2, 5A, and 5B, the plate 3 can also comprise a bulge 311 for ensuring that the frame 4 stays closed in its closed position, by providing a resistance which has to be overcome when closing or opening the frame 4. Alternatively or additionally, the bulge 311 may position the frame 4 such that the bulge 311 is arranged between two of the ribs 41, thereby preventing lateral movement of the frame 4.

While the current invention has been described in relation to its specific embodiments, it is to be understood that this description is for illustrative purposes only. Accordingly, it is intended that the invention be limited only by the scope of the claims appended hereto.

1. A device for manually sealing a multiwell plate, the device comprising:
a multiwell plate holder;
a frame movably arranged and configured to frame the multiwell plate, for holding and centering a precut adhesive foil placed on the multiwell plate, wherein the frame is configured for transmitting a pressure force onto the adhesive foil; and
a handle portion comprising a roller moveable across the frame and the adhesive foil, for applying pressure onto the adhesive foil to thereby seal the multiwell plate.

2. The device of claim 1, wherein the device is configured such that the handle portion can be manually moved from an initial position along the whole length of the multiwell plate to a stopping position and back to the initial position.

3. The device of claim 2, wherein the device is configured such that the frame is only removable from the multiwell plate, and the multiwell plate is only removable from the multiwell plate holder, when the handle portion is in its initial position.

4. The device of claim 1, wherein the frame is movably attached to the multiwell plate holder by means of a hinge, such that the frame can be folded onto the adhesive foil placed on the multiwell plate, and opened again.

5. The device of claim 1, wherein the frame comprises a mechanism for preventing the frame from folding by itself, in particular wherein the hinge is one of a friction and torque hinge.

6. The device of claim 1, wherein the roller comprises a soft material,
wherein, in particular, a hardness of the soft material at 20° C. ranges between 55 and 65 shore A in accordance with DIN 53505, and
wherein, the soft material is a polymer.

7. The device of claim 6, wherein the soft material is polyurethane.

8. The device of claim 1, wherein the handle portion is mounted onto the device by means of a ball bearing mechanism.

9. The device of claim 1, wherein the roller is mounted within the handle portion by means of a ball bearing mechanism.

10. The device of claim 1, wherein the roller is biased away from the handle portion by means of a biasing mechanism, for evenly applying a force onto the frame and onto the adhesive foil placed on the multiwell plate.

11. The device of claim 1, wherein the multiwell plate holder comprises a plurality of support structures arranged in a fixed manner, for supporting and holding in place the multiwell plate.

12. The device of claim 11, wherein the support structures are formed to correspond to a plurality of recesses on the bottom side of a respective multiwell plate, preferably wherein the support structures are formed for accommodating different types of multiwell plates in the multiwell plate holder, and for preventing a deformation of the multiwell plate by directing a force applied by the roller to collars of the respective wells of the multiwell plate, as well as to edge regions of the multiwell plate.

13. The device of claim 11, wherein the support structures each protrude vertically from the multiwell plate holder and/or each have a cross-sectional area that is round or polygonal, in particular quadrangular, such that the support structures each have a conical shape or a pyramid shape, respectively.

14. The device of claim 1, wherein the multiwell plate is a 96- or 384-well-plate.

15. A method for sealing a multiwell plate, the method comprising:
placing a multiwell plate in the multiwell plate holder of the device of claim 1,
placing an adhesive foil onto the multiwell plate,
placing the frame of the device onto adhesive foil and multiwell plate, for centering and holding in place the adhesive foil, and
sealing the multiwell plate by manually moving the handle portion from an initial position along the whole length of the multiwell plate to a stopping position and back to the initial position, for applying pressure onto the adhesive foil by means of the roller of the device.

16. The method of claim 15, wherein the step of sealing the multiwell plate by manually moving the handle portion from an initial position along the whole length of the multiwell plate to a stopping position and back to the initial position is repeated at least once.
